(19) United States
(12) Patent Application Publication
(10) Pub. No.: US 2010/0096906 A1
(43) Pub. Date: Apr. 22, 2010

(54) Rim cover

(76) Inventor: Garry L. Brown, Baltimore, MD (US)

Correspondence Address: RUTH EURE, 4795 EDISON AVENUE, BOULDER, CO, 80301, US

(21) Appl. No.: 12/586,782

(22) Filed: Sep. 28, 2009

Related U.S. Application Data
(60) Provisional application No. 61/194,466, filed on Sep. 26, 2008.

(51) Int. Cl. B60B 7/00

(52) U.S. Cl. 301/37.104

(57) ABSTRACT

The Rim Cover is a specially designed protective shield, specifically intended to protect valuable tire rims from the variety of chemicals typically used when detailing tires. The present invention can be manufactured of coated paperboard or heavy duty plastic material, or of any other suitable material. The Rim Cover can be produced in a variety of sizes appropriate for use with the various size rims available on the market and are a circular, convex unit.

### CLAIM OF PRIORITY

This patent application claims priority under 35 USC 119 (e) (1) from U.S. Provisional Patent Application Ser. No. 61/194,466 filed Sep. 26, 2008 of common inventorship herewith entitled, “The Rim Cover.”

### FIELD OF THE INVENTION

The present invention pertains to the field automotive accessories, and more specifically to the field of wheel covers and even more specifically the field of protective wheel covers to protect ornamental wheel covers during tire leaning.

### BACKGROUND OF THE INVENTION

The prior art has put forth many designs for wheel covers and rim covers.

These include:

U.S. Pat. No. 6,860,568 to Nunes describes a wheel rim cover for a vehicle which comprises a cover for fastening to a wheel rim. This rim cover is bolted onto the rim of the wheel.

U.S. Pat. No. 6,688,703 to Wang describes a wheel rim cover comprising spring loaded fastening means which attach to a wheel rim and create an elevated effect of visual appearance.

U.S. Des. 504,652 to Woodberry describes a vehicle tire rim or hubcap cover for covering the hubcap of a vehicle.

None of these prior art patents describe the present invention.

Countless motorists enjoy an interest in customizing their automobiles. Whether by ordering personalized license plates, attaching fancy mud flaps to the rear tires, installing floating neon lights along the car's undercarriage or airbrushing elaborate designs upon the car's hood and trunk; customizing one's vehicle is truly an exciting and artistic way in which to express one's self.

An extremely popular way in which people revamp the overall appearance of their cars, trucks and vans, is by installing a new set of tires. Produced in a variety of styles, such as mag wheels, low profile, whitewashed and modular, a new set of tires can vastly improve the appearance of any auto. Although most car enthusiasts would agree that “the right” tires are a crucial element to the overall design of their automobile, it is common knowledge that a set of high-polished rims can add the perfect finishing touch. Like tires, rims are produced in a wide variety of styles and materials and are continually developed in new and unique varieties of rims to entice the car enthusiast. Whether shiny chrome, gold plated or polished aluminum, rims are an attractive accessory that all automobile aficionados recognize as an important design element.

Although clean and polished rims are an attractive component of any automobile, caring for rims properly can be somewhat challenging. Specifically, many consumers find that the solvents and cleansers used to detail the car's tires can leave unattractive and, in some cases, permanent stains and residues on the rims. Requiring extra work and extensive scrubbing, these streaks and stains can be a costly nuisance. In fact, with a set of rims costing anywhere between a few hundred to several thousand dollars, proper maintenance of these valuable commodities is of utmost importance.

Recognizing the need for a product that would protect rims from the polishes, solvents and tire dressings used to clean tires, the present invention was developed, and is hereinafter referred to as The Rim Cover.

### BRIEF DESCRIPTION OF THE DRAWINGS

FIG. 1 is a perspective view of a pair of rim covers in accordance with the present invention.

FIG. 2 is a perspective view of the present invention mounted on the tire of a car.

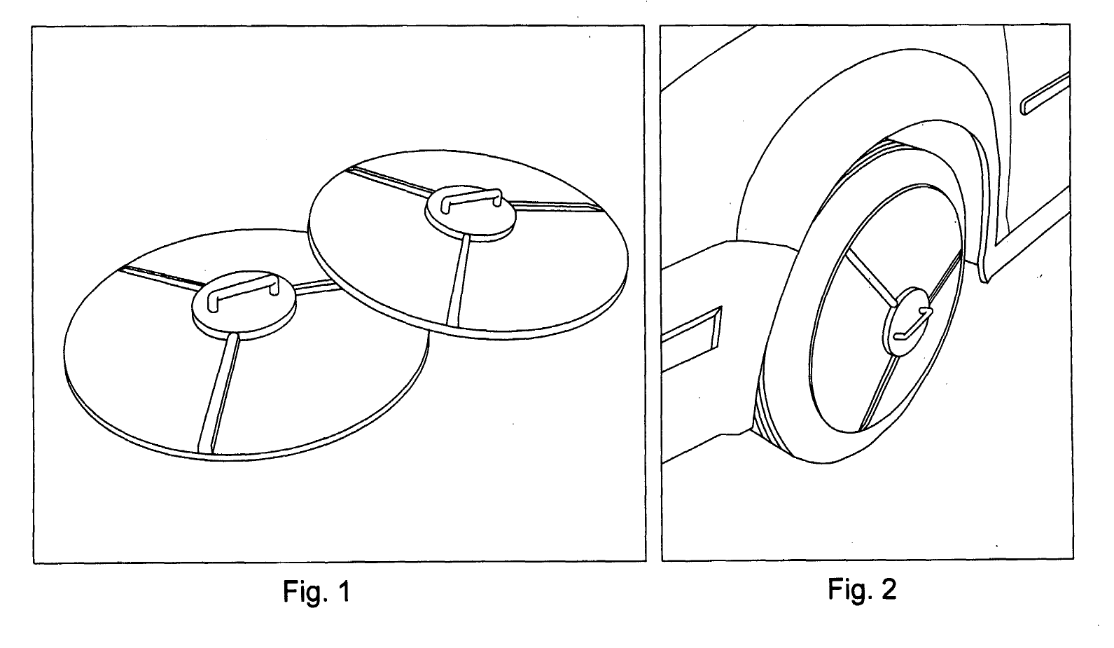

### DETAILED DESCRIPTION OF THE INVENTION

The Rim Cover is a specially designed protective shield, specifically intended to protect valuable tire rims from the variety of chemicals typically used when detailing tires. The present invention can be manufactured of coated paperboard or heavy duty plastic material, or of any other suitable material. The Rim Cover can be produced in a variety of sizes appropriate for use with the various size rims available on the market and are a circular, convex unit.

To prevent fluids from leaking beneath the rim cover during use, the outer edge of the unit is gently tapered to ensure a custom and secure fit. This can be achieved by incorporating a flexible rubber or plastic lip into the design of the outer edge, thus creating a powerful suction force which provides an impenetrable, waterproof barrier between the actual tire rim and the solvents and chemicals used to clean the tire.

For practical purposes, a “U” shaped handle is positioned on the front center of the cover, thus facilitating application and removal.

Use of The Rim Cover is very simple and straight forward. First, the user chooses the size of The Rim Cover appropriate for their car's tires and rims. Next, the user places The Rim Cover directly over the tire rim, holding the rim cover by way of the integrated handle. Once applied, the rim cover is pressed firmly against the tire, creating a powerful suction force which provides a waterproof seal along the inner edge of the tire and the outer edge of the tire rim. The user then washes and details their tires per their normal routine. Scrubbing the tires with warm, soapy water, chemical solutions or solvents, the user then may use a small stiff brush to clean the tire side walls. After the tires were clean and had thoroughly dried, the user may next apply a spray-on or liquid tire dressing. Once the dressing had dried completely, the user simply removes The Rim Cover gently pulling the unit away from the rim. If desired, the rims could then be polished and the car would be ready to go!

There are many significant benefits and advantages associated with The Rim Cover. Foremost, once applied, this cleverly designed product completely shrouds the tire rim in a protective armor. Providing an easy means for the car enthusiast to completely clean and detail their tires, use of The Rim Cover ensures that expensive tire rims are fully protected from the harsh chemicals and dressings used to enhance the appearance of the tires. Gently contoured for a secure, customized fit, use of The Rim Cover eliminates the unattractive streaks, stains and marks that are associated with the use of these solvents, therefore possibly extending the life of the tire rim. Not limited to use when detailing the rims, The Rim Cover can also be utilized when storing one's vehicle. Simply stated, by applying four The Rim Covers, one to each tire, the user ensures that tire rims maintain their pristine appearance, particularly when parked or stored for extended periods. Providing automobile enthusiasts with a simple means of improving the appearance of their vehicle, The Rim Cover offers the car lover a unique means in which to safely transform their tires from functional necessities into extraordinary showpieces. Auto lovers who collect vintage automobiles or who enjoy restoring newer cars, will especially appreciate the benefits associated with this protective product. Perfect for home use, The Rim Cover also proves a valuable tool for professional car restorers, detailers and automotive specialists.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cover for a wheel rim, comprising a convex disc having a diameter appropriate to the rim, and wherein the outer edge of the disc is gently tapered to ensure a custom and secure fit;
further comprising a handle in the center of the outside of the cover.

2. The rim cover of claim 1 further comprising a flexible rubber or plastic lip on the outer edge of the gently tapered edge of the disc, thus creating a powerful suction force which provides an impenetrable, waterproof barrier between the actual tire rim and the solvents and chemicals used to clean the tire.

3. The rim cover of claim 2 wherein the rim cover is comprised of coated paperboard or heavy duty plastic material.

4. A method of using a rim cover comprising:
a) choosing the size of The Rim Cover appropriate for their car's tires and rims;
b) placing The Rim Cover directly over the tire rim while holding the rim cover by way of the integrated handle;
c) pressing the rim cover firmly against the tire, creating a powerful suction force which provides a waterproof seal along the inner edge of the tire and the outer edge of the tire rim;
d) washing and detailing tires per their normal routine; and when completed,
e) removing the rim cover by gently pulling the unit away from the rim.
